(19) United States
(12) Patent Application Publication
(10) Pub. No.: US 2008/0150744 A1
(43) Pub. Date: Jun. 26, 2008

(54) Method for Correcting a Position Sensor, Delay Between the Passage of a Magnetic Element and a Detected Logic Signal, and Sensor Used Therefor

(75) Inventor: Laurent Dufour, Meximieux (FR)

Correspondence Address: DENNISON, SCHULTZ & MACDONALD, 1727 KING STREET, SUITE 105, ALEXANDRIA, VA, 22314, US

(73) Assignee: ELECTRICFIL AUTOMOTIVE, Miribel (FR)

(21) Appl. No.: 10/597,638

(22) PCT Filed: Feb. 4, 2005
(86) PCT No.: PCT/FR2005/000255

§ 371 Date: Oct. 4, 2006

(30) Foreign Application Priority Data
Feb. 6, 2004 (FR) 0401167

(51) Int. Cl. G08B 21/00

(52) U.S. Cl. 340/686.1

(57) ABSTRACT

A position sensor includes at least two detection cells which are separated according to the direction of relative displacement between a generator element and cells of a given value such that a cell detects at least one first magnetic transition of the generator element in order to obtain a logic signal with at least one commutation front corresponding to the determined position of a first variation front. The other cell detects at least a second magnetic transition of the generator element in order to obtain a logical signal with at least one commutation front corresponding to the determined position of the second variation front. Treatment means combine electric signals of the detection cells in order to obtain an electric logic signal corresponding to an electric reference signal.

The subject of the present invention pertains to the technical area of magnetic sensors of the type comprising an encoding element moving in the vicinity of at least one detection system, adapted to identify at least one angle position in the general meaning.

The subject of the invention finds particularly advantageous applications in the automotive sector in which said sensor can be used to detect the position of a mobile for example, in particular part of the ignition functions or gear changes.

In the prior art, it is known to use a magnetic sensor adapted to measure the change in intensity of a magnetic field when an encoder, associated with the mobile whose position is to be determined, travels in front of a detection system comprising one or more measurement or detection cells. The encoder is provided with at least one element generating a variable magnetic field having two magnetic transitions that are separated from each other over a given width. Each detection cell, such as a Hall Effect Probe or magnetoresistive sensor, delivers a periodic signal corresponding to changes in intensity of the magnetic field generated by the generator elements. Each detection cell is associated with a hysteresis level comparator such as a Schmitt trigger to obtain a logic electric signal comprising switching edges for separate values of the magnetic field according to whether it varies increasingly or decreasingly.

In various applications such as a rotation sensor, there exists a major drawback regarding the phase difference existing between the passing of the magnetic transitions of the generator elements and the position of the switching edges of the logic electric signal delivered by the detection system.

Said drawback is apparent for example in the case when the position of the mobile to be identified is of narrow width in the direction of movement. This is particularly the case with the gear change lever in a motor vehicle. According to this application, it is sought to obtain a logic signal of which one status represents a particular position or group of positions, whereas the other status represents the other positions. It can be considered to detect the “neutral” position by logic status 0 and the other positions by logic status 1. For this purpose, the encoder is provided as a magnetized support linked to the gear lever and comprising an element generating a magnetic field having magnetization in the opposite direction to the adjacent areas. Yet the position of the switching point heavily depends upon the value of the air gap between the encoder and the detection cell, which means that in practice there is a variation in the air gap making it impossible to guarantee the reliable detection of the mobile's position.

The above-mentioned drawback is also apparent for a position sensor adapted to be compatible with the True Power On (TPO) function, i.e. the ability to allow the determination, as soon as the sensor is switched on, of the position of the generator element with respect to the detection cell. The disadvantage of said sensor is that it detects the generator element i.e. the cog after it has moved away from the sensor and before it draws close to it, which gives rise to a major phase difference between the electric signal and the passing of the encoder cog since the falling switching edge of the signal is too late with respect to the passing of the cog, whereas the rising switching edge is too early.

The object of the present invention is therefore to overcome the above-mentioned disadvantages by proposing a method with which it is possible, for a position sensor, to correct the phase difference between the passing of a magnetic element in front a detection system and the detected logic signal.

To reach said objective, the subject of the invention sets out to propose a method of correcting, for a position sensor, the phase difference between firstly the relative passing of at least one first and one second magnetic transition of an element generating a variable magnetic field in front of a detection system comprising at least two detection cells, and secondly the position of at least two switching edges of a logic electric signal delivered by the detection system, the two magnetic transitions being separated from each other by a given width in the direction of relative movement between the generator element and the detection system.

According to the invention, the method consists of:
choosing the form of a reference logic electric signal by determining the position of at least one first and one second variation edge,
separating the detection cells in the direction of movement by a given value so that one cell detects at least the first magnetic transition to obtain a logic signal with at least one switching edge corresponding to the determined position of the first variation edge, whilst the other cell detects at least the second magnetic transition to obtain a logic signal with at least one switching edge corresponding to the determined position of the second variation edge,
and of combining the logic signals delivered by the detection cells so as to obtain a logic electric signal corresponding to the reference electric signal.

According to a first variant of embodiment the method of the invention consists of:
choosing the form of a reference logic electric signal corresponding to the passing in front of the detection system by a reference generator element having a given width smaller than the width of the generator element passing in front of the detection system, and
spacing the detection cells so that the logic electric signal obtained is in phase with the passing of the reference generator element in front of the detection system.

Advantageously the method consists of providing the generator element with magnetization in the opposite direction to that of the areas adjacent to said generator element.

According to this first variant of embodiment, the method consists of combining the logic signals delivered by the detection cells taking into account those parts of the signals simultaneously having one same logic status between the switching edges, with a view to obtaining the logic electric signal in phase with the passing of the reference generator element.

According to a second variant of embodiment, the method consists of:
choosing the form of a reference logic electric signal corresponding to the passing of a generator element in front of the detection system and
spacing the two detection cells so that the logic electric signal obtained is in phase with the passing of a generator element.

According to this second variant of embodiment, the method consists of combining the logic signals delivered by the detection cells taking into account those parts of the signals simultaneously having one same logic status between the switching edges, with a view to obtaining a logic electric signal in phase with the passing of a generator element.

Advantageously, the inventive method consists of using the logic signals delivered by the detection cells with a view to determining the direction of rotation of the generator element.

A further purpose of the invention is to propose a sensor comprising at least one element generating a variable magnetic field comprising a first and second magnetic transition, and intended to travel in front a detection system comprising at least two detection cells and delivering a logic electric signal comprising at least two switching edges and corresponding to changes in the magnetic field generated by the element, the detection cells being linked to means for processing electric signals delivered by the detection cells.

According to the invention, the detection cells are spaced apart in the direction of relative movement between the generator element and the detection system, by a given value so that one cell detects at least the first magnetic transition to obtain a logic signal with at least one switching edge corresponding to the position determined for the first variation edge, whilst the other cell detects at least the second magnetic transition to obtain a logic signal with at least one switching edge corresponding to the position determined for the second variation edge, and in that the processing means combine the electric signals of the detection cells so as to obtain a logic electric signal corresponding to a reference electric signal.

According to a first variant of embodiment, the detection cells are spaced by a given value so that the logic electric signal obtained is in phase with the passing of a reference generator element having a given width smaller than the width of the generator element and which allows the obtaining of the reference electric signal.

The processing means combine the logic signals delivered by the cells taking into account those parts of the signals simultaneously having one same logic status between the switching edges, with a view to obtaining the logic electric signal in phase with the passing of the reference generator element.

According to a second variant of embodiment, the detection cells are spaced by a given value so that the logic electric signal obtained is in phase with the passing of a generator element.

Advantageously, the processing means comprise means for using the logic signals delivered by the detection cells with a view to determining the direction of rotation of the generator element.

Various other characteristics will become apparent on reading the following description with reference to the appended drawings which, as non-limitative examples, illustrate forms of embodiment of the subject of the invention.

FIG. 1 is a perspective view showing a characteristic detail of an encoder used in a first application of the inventive position sensor.

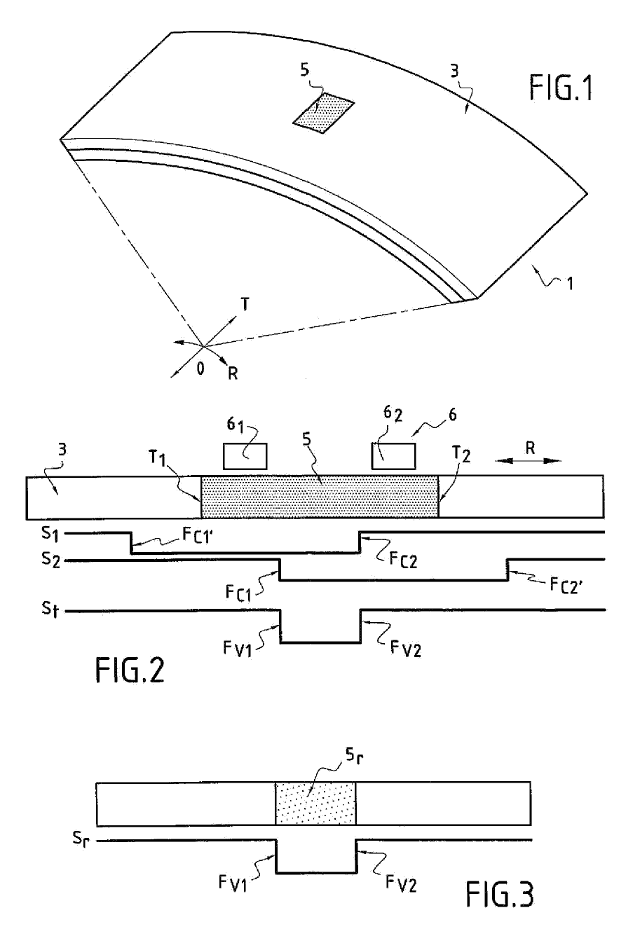

FIG. 2 is a view on a larger scale showing the encoder illustrated FIG. 1 with which measurement chronograms are associated.

FIG. 3 gives a view of a reference encoder associated with a measurement chronogram.

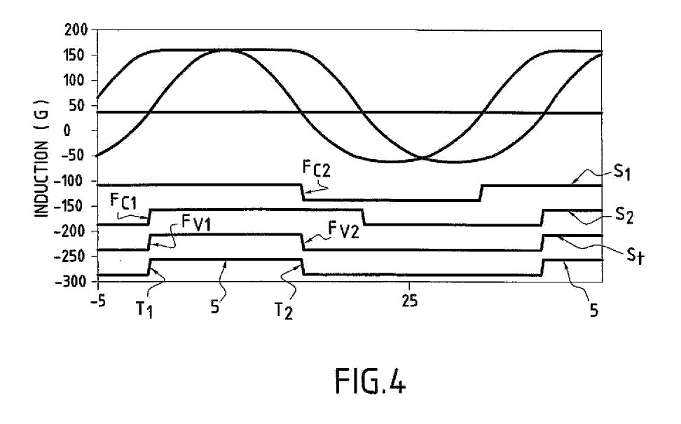

FIG. 4 shows different measured chronograms under a second application of an inventive position sensor.

FIGS. 1 and 2 illustrate a first example of application of the subject of the invention with a position sensor 1 able to detect the position of a mobile element in two degrees of freedom and to provide information representing an area in which the mobile element is located. The degrees of freedom of the mobile may be translation along two axes defining a translation plane, rotation about two axes or, as in the illustrated example, the combination of a translation represented by arrow T and a rotation R along axis O. One possible application is the identification of a particular position of a mobile such as a gear change lever in a motor vehicle for example.

According to this example of embodiment, the position sensor 1 comprises an encoder 3 containing at least one, and in the illustrated example one element 5 generating a variable magnetic field, intended to travel in front of a detection system 6. In the illustrated example, the encoder 3 consists of a magnetized drum carrying a generator element 5 such as a magnetization pattern of opposite direction to the direction of magnetization of the adjacent areas. This generator element 5 therefore comprises a first T₁ and second T₂ magnetic transition in the direction R of relative movement between element 5 and the detection system 6.

According to the invention, the detection system 6 comprises a first 6₁ and second 6₂ detection or measurement cell which each deliver an analog electric signal corresponding to changes in the intensity of the magnetic field delivered by the encoder 3. The output of detection cells 6₁, 6₂ is connected to means, not shown, for processing electric signals delivered by the cells making it possible to obtain logic electric signals.

According to this example of embodiment, it is to be considered that the size of the area to be distinguished is small along direction R. Therefore the measurement of induction made by cells 6₁, 6₂ is highly sensitive to variation in the air gap i.e. the distance between the generator element 5 and the cells 6₁, 6₂. Therefore the switching edges of the logic electric signals, with respective low and high air gap, change. To overcome this disadvantage the object of the invention is to provide a generator element 5 having a greater width than the generator element corresponding to the area to be detected.

In other words, the object of the invention, as illustrated more particularly FIG. 3, is to choose the form of a reference logic electric signal Sᵣ by determining the position of at least one first Fv₁ and one second Fv₂ variation edge corresponding to the passing of the magnetic transitions of a reference generator element 5ᵣ having a width adapted to the area to be detected. In other words, the inventive method consists of taking into account the position of the variation edges Fv₁, Fv₂ of a logic signal obtained by the passing of a so-called reference generator element 5ᵣ in front of the detection system, the width of this generator element corresponding to the area in which the position of the mobile is to be identified.

Another aspect of the invention is to space the detection cells 6₁, 6₂ in the direction of movement R by a given value so that one cell e.g. 6₂ is able to obtain the position of a variation edge such as Fv₁ whilst the other cell, namely 6₁, is able to allow obtaining of the position of the other variation edge, namely Fv₂. As shown clearly FIG. 2, each cell 6₁, 6₂ makes it possible to obtain a logic electric signal S₁, S₂ shifted by the value of their spacing and each comprising switching edges (Fc_{1′}, Fc₂-Fc₁, Fc_{2′}) corresponding to the passing of the magnetic transitions T₁,T₂. According to the invention, the logic electric signals S₁, S₂ respectively obtained by cells 6₁, 6₂ respectively comprise at least one switching edge Fc₂, Fc₁ respectively corresponding to the positions of the second Fv₂ and first Fv₁ variation edges of the reference logic signal Sᵣ.

As arises from the preceding description, the spacing between cells 6₁, 6₂ and the width between the magnetic transitions T₁, T₂ of the generator element 5 are chosen so that each cell takes part in locating a variation edge of the reference logic signal Sᵣ.

According to the invention, the processing means combine the logic signals S₁, S₂ obtained by the detection cells 6₁, 6₂ so as to produce a logic electric signal Sₜ corresponding to the reference electric signal Sᵣ. In the illustrated example, the processing means therefore take into account those parts of signals S₁, S₂ simultaneously having one same logic status between the switching edges Fc₁, Fc₂ to obtain the logic electric signal Sₜ in phase with the passing of the reference generator element 5ᵣ. In the illustrated example, the two logic electric signals S₁ and S₂ are combined by means of a logic OR gate so as to obtain the logic signal Sₜ.

It arises from the preceding description that the inventive method consists of choosing the form of a reference logic electric signal Sᵣ corresponding to the passing in front of the detection system 6 by a reference generator element 5ᵣ having a given width corresponding to the area to be detected and smaller than the width of the generator element 5 actually passing in front of the detection system 6. Insofar as the generator element 5 is of greater width than the reference generator element 5ᵣ which should have been provided to detect the position of the mobile, the sensor appears to show little sensitivity to variations in the air gap.

The object of the invention is also application to a position sensor compatible with the True Power On (TPO) function. In this application, it is known to provide the encoder with a series of elements 5 generating a variable magnetic field, arranged regularly around a circumference.

According to a first known form of embodiment, the generator elements 5 consist of elements disturbing a magnetic field set up by a fixed magnet positioned in the vicinity of said disturbing elements. For example said disturbing elements consist of cogs arranged in a ferromagnetic ring. According to a second form of embodiment the elements generating a variable magnetic field are formed by magnetic poles regularly spaced apart by a given pitch. Said encoder is therefore in the form of a multipolar magnetic ring.

According to this application, the object of the invention consists of choosing the form of a reference logic electric signal Sᵣ, corresponding to the passing of generator elements 5 in front of the detection system 6 so that the magnetic transitions T₁, T₂ of each generator element 5 are in phase with the switching edges Fv₁, Fv₂ of the logic electric signal Sᵣ.

According to the invention, the two detection cells 6₁ and 6₂ are spaced so that the logic electric signal Sₜ obtained is in phase with the passing of each generator element 5. Therefore, as clearly illustrated FIG. 4, the detection cells 6₁, 6₂ are spaced apart in the direction of movement so that one cell e.g. 6₂ detects at least the first magnetic transition T₁ to obtain a logic signal S₂ with at least one switching edge Fc₁ corresponding to the position determined for the first variation edge Fv₁, whilst the other cell 6₁ detects at least the second magnetic transition T₂ to obtain a logic signal S₁ with at least one switching edge Fc₂ corresponding to the position determined for the second variation edge Fv₂.

The logic signals S₁, S₂ delivered by the detection cells are combined by taking into account those parts of the signals simultaneously showing one same logic status between the switching edges Fc₁, Fc₂ with a view to obtaining the logic electric signal Sₜ comprising the variation edges Fv₁, Fv₂ and in phase with the passing of each generator element 5.

According to one characteristic of the invention provision is made to use the logic signals delivered by the detection cells with a view to determining the direction of movement of the generator element. The presence of logic signals S₁, S₂ slightly out of phase with each other, allows easy determination of the direction of movement. Persons skilled in the art know for example the use of a trigger D to achieve this type of function taking into consideration the logic status of one of the two signals e.g. S₂ at the time of the rising edge of the other signal, namely S₁. In this case the output of trigger D, at the time of the rising edge of signal S₁, assumes a high or low logic status representing the direction of movement. Evidently it could be considered to use more sophisticated logic processing to detect direction of movement with a view to obtaining more rapid information on the direction of movement.

The invention is not limited to the described, illustrated examples since various modifications may be made thereto without departing from the scope thereof.

1. Method, for a position sensor, of correcting the phase difference between firstly the relative passing of at least one first (T₁) and one second (T₂) magnetic transition of a generator element (5) generating a variable magnetic field, in front of a detection system (6) comprising at least two detection cells (6₁, 6₂), and secondly the position of at least two switching edges (Fc₁, Fc₂) of a logic electric signal delivered by the detection system, the two magnetic transitions (T₁, T₂) being separated from each other by a given width in the direction of relative movement between the generator element (5) and the detection system (6),
characterized in that it consists of:
choosing the form of a reference logic electric signal (Sᵣ) by determining the position of at least one first and one second variation edge (Fv₁, Fv₂),
spacing the detection cells (6₁, 6₂) in the direction of movement by a given value so that one cell detects at least the first magnetic transition (T₁) to obtain a logic signal (S₂) with at least one switching edge (Fc₁) corresponding to the position determined for the first variation edge (Fv₁), whilst the other cell detects at least the second magnetic transition (T₂) to obtain a logic signal (S₁) with at least one switching edge (Fc₂) corresponding to the position determined for the second variation edge (Fv₂),
and of combining the logic signals delivered by the detection cells so as to obtain a logic electric signal (Sₜ) corresponding to the reference electric signal (Sᵣ).

2. Method as in claim 1, characterized in that it consists of:
choosing the form of a reference logic electric signal (Sᵣ) corresponding to the passing, in front of a detection system (6), by a reference generator element (5ᵣ) having a given width smaller than the width of the generator element (5) passing in front of the detection system (6),
and of spacing the two detection cells (6₁, 6₂), so that the logic electric signal obtained (Sₜ) is in phase with the passing of the reference generator element (5ᵣ) in front of the detection system (6).

3. Method as in claim 2, characterized in that it consists of providing the generator element (5) with magnetization in opposite direction to that of the areas adjacent to said generator element.

4. Method as in claim 2, characterized in that it consists of combining the logic signals (S₁, S₂) delivered by the detection cells by taking into account those parts of the signals simultaneously having one same logic status between the switching edges (Fc₁, Fc₂) with a view to obtaining the logic electric signal (Sₜ) in phase with the passing of the reference generator element (5ᵣ).

5. Method as in claim 1, characterized in that it consists of:
choosing the form of a reference logic electric signal (Sᵣ) corresponding to the passing of a generator element (5) in front of the detection system (6),
and of spacing the detection cells (6₁, 6₂) so that the logic electric signal (Sₜ) obtained is in phase with the passing of a generator element (5).

6. Method as in claim 5, characterized in that it consists of combining the logic signals (S₁, S₂) delivered by the detection cells (6₁, 6₂) taking into account those parts of the signals simultaneously having one same logic status between the switching edges (Fc₁, Fc₂) with a view to obtaining a logical electric signal (Sₜ) in phase with the passing of a generator element (5).

7. Method as in claim 6, characterized in that it consists of using the logic signals (S₁, S₂) delivered by the detection cells (6₁, 6₂) with a view to determining the direction of rotation of the generator element.

8. Position sensor comprising at least one generator element (5) generating a variable magnetic field comprising a first (T₁) and a second magnetic transition (T₂), and intended to travel in front of a detection system (6) comprising at least two detection cells (6₁, 6₂) and delivering a logic signal comprising at least two switching edges (Fc₁, Fc₂) and corresponding to changes in the magnetic field generated by the element, the detection cells being linked to means for processing electric signals delivered by the detection cells,
characterized in that the detection cells (6₁, 6₂) are spaced apart in the direction of relative movement between the generator element (5) and the detection system (6) by a given value so that one cell detects at least the first magnetic transition (T₁) to obtain a logic signal (S₂) with at least one switching edge (Fc₁) corresponding to the position determined for the first variation edge (Fv₁), whilst the other cell detects at least the second magnetic transition (T₂) to obtain a logic signal (S₁) with at least one switching edge (Fc₂) corresponding to the position determined for the second variation edge (Fv₂), and in that the processing means combine the electric signals (S₁, S₂) of the detection cells so as to obtain a logic electric signal (Sₜ) corresponding to a reference electric signal (Sᵣ).

9. Position sensor as in claim 8, characterized in that the detection cells (6₁, 6₂) are spaced by a given value so that the logic electric signal obtained (Sₜ) is in phase with the passing of a reference generator element (5ᵣ) having a given width smaller than that of the generator element (5), making it possible to obtain the reference electric signal (Sᵣ).

10. Sensor as in claim 8, characterized in that the processing means combine the logic signals (S₁, S₂) delivered by the cells taking into account those parts of the signals simultaneously having one same logic status between the switching edges (Fc₁, Fc₂) with a view to obtaining the logic electric signal (Sᵣ) in phase with the passing of the reference generator element (5ᵣ).

11. Position sensor as in claim 8, characterized in that the detection cells (5₁, 5₂) are spaced by a given value so that the logic electric signal obtained (Sₜ) is in phase with the passing of a generator element (5).

12. Position sensor as in claim 8, characterized in that the processing means comprise means for using the logic signals (S₁, S₂) delivered by the detection cells (6₁, 6₂) with a view to determining the direction of rotation of the generator element.
